(19) United States
(12) Patent Application Publication
(10) Pub. No.: US 2009/0153462 A1
(43) Pub. Date: Jun. 18, 2009

(54) ILLUMINATION DEVICE AND DISPLAY APPARATUS PROVIDED WITH THE SAME

(75) Inventors: Kentaro Kamada, Mie (JP); Yoshiki Takata, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: Sharp Kabushiki Kaisha, Osaka-shi, Osaka (JP)

(21) Appl. No.: 12/096,420

(22) PCT Filed: Aug. 25, 2006
(86) PCT No.: PCT/JP2006/316765

§ 371 Date: Jun. 6, 2008

(30) Foreign Application Priority Data
Dec. 8, 2005 (JP) 2005-355312

(51) Int. Cl. G09G 3/36; G02F 1/13357

(52) U.S. Cl. 345/102; 362/97.1

(57) ABSTRACT

A display apparatus that can perform a high quality moving picture display and provides improved color purity, and an illumination device used in the display apparatus are provided. The display apparatus includes an illumination device that includes a first light source that emits light of a first color and a second light source that emits light of a second color complementary to the first color, a gate driver that sequentially selects each of scanning lines at a cycle of 0.5 frames, a data driver that, at a first half of one frame time period, writes a data signal into each of pixels of the first color, and at a latter half thereof, writes a data signal into each of pixels of the other two colors; and a switch circuit that, at the first half of one frame time period, switches on the first light source while switching off the second light source, and at the latter half of the time period, switches on the second light source while switching off the first light source.

### BACKGROUND OF THE INVENTION

1. Field of the Invention

The present invention relates to an illumination device used as a backlight of a display apparatus and to a display apparatus provided with the same. More specifically, the present invention relates to an illumination device and a display apparatus that provide improved color purity in a color display.

2. Description of the Related Art

In recent years, as a display apparatus for a television receiver or the like, liquid crystal display apparatuses characterized by, for example, being reduced in power consumption, thickness and weight have found widespread use. A liquid crystal display element per se does not emit light and thus is a so-called non-light-emitting type display element. Therefore, for example, on one principal surface of the liquid crystal display element, a plane light-emitting type illumination device (so-called backlight) is provided.

Backlights are classified roughly as either a direct type and a sidelight (referred to also as “edge-light”) type depending on an arrangement of a light source with respect to a liquid crystal display element. A direct type backlight has a configuration in which a light source is disposed on a rear surface side of a liquid crystal display element, and a diffusing plate, a prism sheet and the like are disposed between the light source and the liquid crystal display element so that uniform plane-shaped light is made incident on an entire rear surface of the liquid crystal display element. Such a direct type backlight has been used suitably in, for example, a large-screen liquid crystal display apparatus for a television receiver.

As a conventional light source for a backlight, a cold cathode fluorescent tube (CCFT) has been in common use. Further, with the recent advancement in development of a light-emitting diode (LED) having higher color reproducibility than a cold cathode fluorescent tube, a LED also has been used suitably as a light source for a backlight.

Furthermore, conventionally, a color display has been realized by color filters of three colors of RGB that are provided so as to correspond to pixels of a liquid crystal display element. FIG. 14 is a schematic diagram showing a structure of an active matrix substrate in a conventional active matrix type liquid crystal display element, in which each pixel is shown with a color of color filters corresponding thereto. As shown in FIG. 14, the active matrix substrate includes scanning lines GL and data lines DL that are arranged in a matrix form, a TFT 101 that is disposed at each of intersections of the scanning lines GL and the data lines DL, and a pixel electrode 102 that is connected to a drain electrode of the TFT 101. On an opposing substrate (not shown) opposed to this active matrix substrate, color filter layers of three colors of RGB are formed in stripes. Thus, as shown in FIG. 14, all of pixels in one column connected commonly to each of the data lines DL display one of the colors of RGB. For example, in FIG. 14, all of pixels connected to the data line DL1 display red.

In the active matrix type liquid crystal display element configured as described above, when a gate pulse (selective voltage) is applied sequentially to the scanning lines GL1, GL2, GL3, GL4, . . . , each of the TFTs 101 connected to one of the scanning lines GL, to which the gate pulse has just been applied, is brought to an ON state, and a value of a gradation voltage that has been applied to a corresponding one of the data lines DL at that point in time is written into the each of the TFTs 101. Consequently, a potential of the pixel electrode 102 connected to a drain electrode of the each of the TFTs 101 becomes equal to the value of the gradation voltage of the corresponding one of the data lines DL. As a result of this, an orientation state of liquid crystals interposed between the pixel electrode 102 and an opposing electrode changes in accordance with the value of the gradation voltage, and thus a gradation display of the pixel is realized. On the other hand, during a time period in which a non-selective voltage is applied to the scanning lines GL, the TFTs 101 are brought to an OFF state, so that the potential of the pixel electrode 102 is maintained at a value of a potential applied thereto at the time of writing.

As described above, in the conventional liquid crystal display element, the color filters of three colors of RGB are arranged in an orderly manner, and while the scanning lines GL are selected sequentially in one frame time period, a gradation voltage of a desired value is applied to each of pixels that correspond to each of the colors of RGB from a corresponding one of the data lines DL, thereby realizing a color display.

As a CCFT used as a light source for a backlight of the above-described conventional liquid crystal display element that performs a color display, a three-wavelength tube or a four-wavelength tube is in general use. The three-wavelength tube is a fluorescent tube having wavelengths of red (R), green (G), and blue (B), and the four-wavelength tube is a fluorescent tube having wavelengths of red, green, blue, and deep red. In the case of the three-wavelength tube, red, green, and blue phosphors are sealed in the tube. In the case of the four-wavelength tube, red, green, blue, and deep red phosphors are sealed in the tube. In either of these cases, at the time of lighting, mixing of light of the respective wavelengths occurs, so that the liquid crystal display element is irradiated with the light that is light (white light) having an emission spectrum in all wavelength regions. Further, in the case where a LED is used as a light source for a backlight, a prism sheet, a diffusing plate and the like are used to mix the respective colors of light outputted from a red LED, a green LED, and a blue LED (a white LED further may be used) so as to form uniform white light, with which the liquid crystal display element then is irradiated.

The following describes a problem with the case where a light source having wavelength regions of the respective colors of red, green, and blue is used as a light source for a backlight.

FIG. 15 is a spectrum diagram showing spectral transmission characteristics of color filters of three colors of RGB. As shown in FIG. 15, the respective transmission spectra of the blue color filter and the green color filter overlap in an area defined by a range of about 470 nm to 570 nm. Further, the respective spectral transmission spectra of the green color filter and the red color filter overlap in an area defined by a range of about 575 nm to 625 nm. Because of this, in the case of using a light source for a backlight having an emission spectrum in all wavelength regions, color mixing occurs in these areas in which the respective spectral transmission spectra overlap, resulting in deterioration in color purity, which has been disadvantageous.

For example, FIG. 16A shows an emission spectrum of a three-wavelength tube, FIG. 16B shows a spectral transmission characteristic of a red color filter in the case where this three-wavelength tube is used as a light source for a backlight, FIG. 16C shows a spectral transmission characteristic of a green color filter in the case where this three-wavelength tube is used as the light source for the backlight, and FIG. 16D shows a spectral transmission characteristic of a blue color filter in the case where this three-wavelength tube is used as the light source for the backlight.

As can be seen from FIG. 16C, a spectral transmission curve of the green color filter partially overlaps a wavelength region of blue. This means that a blue component is mixed into a pixel that is to be displayed in green. Further, as can be seen from FIG. 16D, a spectral transmission curve of the blue color filter also partially overlaps a wavelength region of green. This means that a green component is mixed into a pixel that is to be displayed in blue. Such a color mixing phenomenon occurs also in the case of using a four-wavelength tube is used as a light source for a backlight and has been a cause of deterioration in color purity.

Conventionally, in order to obtain improved color purity, a driving method (so-called field sequential driving) has been proposed in which LEDs of three colors of RGB are used as light sources for a backlight with respect to a liquid crystal display element including color filters of three colors of RGB, and the LEDs of the respective colors are caused to blink sequentially so that an image of red alone, an image of green alone, and an image of blue alone are displayed in order in one frame (see, for example, JP 2003-271100 A, paragraphs [0064] to [0076], and JP 2005-70421 A).

However, in the above-described configuration according to the conventional technique, when a frame rate is increased such as in the case where a moving picture display of a high-resolution image is performed, a problem arises that the field sequential driving in which a display is performed in a manner that one frame is divided into three colors hardly can be performed. Particularly, in the case of a liquid crystal display apparatus, at least presently, a response speed of liquid crystals is not so high as to be sufficient, rendering it almost impossible to realize a high quality moving picture display by the field sequential driving.

### SUMMARY OF THE INVENTION

In order to overcome the problems described above, preferred embodiments of the present invention provide a display apparatus that can perform a high quality moving picture display and provides improved color purity, and an illumination device included in such a novel display apparatus.

An illumination device according to a preferred embodiment of the present invention is an illumination device that is used as a backlight of a display apparatus and is characterized in that the device includes: a first light source that emits light of a first color; and a second light source that emits light of a second color complementary to the first color, and the first light source and the second light source can be controlled so as to be switched on independently of each other.

Furthermore, a display apparatus according to a preferred embodiment of the present invention includes a display element that includes: scanning lines and data lines that are arranged in a matrix form; a switching element that is connected to each of the scanning lines and a corresponding one of the data lines; a pixel portion that performs a gradation display in accordance with a data signal written from the corresponding one of the data lines when the switching element is brought to an ON state based on a signal of the each of the scanning lines; and color filters that are arranged so as to correspond to the pixel portions and include at least filters of three colors that exhibit a white color when mixed; an illumination device that outputs plane-shaped light to the display element and includes a first light source that emits light of a first color that is one of the three colors and a second light source that emits light of a second color complementary to the first color; a scanning line driving portion that sequentially supplies a selection signal to each of the scanning lines at a cycle of half a time period in which one image is displayed in the display element; a data line driving portion that, at one of a first half and a latter half of the time period in which one image is displayed in the display element, supplies a data signal to be written into each in a group of pixel portions among the pixel portions that corresponds to the color filter of the first color to a corresponding one of the data lines, and at another of the first half and the latter half of the time period, supplies a data signal to be written into each in groups of pixel portions among the pixel portions that correspond respectively to the color filters of two colors among the three colors other than the first color to a corresponding one of the data lines; and a light source driving portion that, at the one of the first half and the latter half of the time period in which one image is displayed in the display element, switches on the first light source while switching off the second light source, and at the other of the first half and the latter half of the time period, switches on the second light source while switching off the first light source.

According to a preferred embodiment of the present invention, it is possible to provide a display apparatus that can perform a high quality moving picture display and provides improved color purity, and an illumination device included in such a display apparatus.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view schematically showing a configuration of a liquid crystal display apparatus according to a preferred embodiment of the present invention.

FIG. 2 is a block diagram showing a functional configuration of the liquid crystal display apparatus according to a first preferred embodiment of the present invention.

FIG. 3 is a timing chart showing one example of a relationship among timing for switching on/off light sources, timing for supplying a data signal to each of data lines, and amounts of light emitted by the light sources in the liquid crystal display apparatus according to the first preferred embodiment of the present invention.

FIG. 4 is a timing chart showing another example of the relationship among timing for switching on/off the light sources, timing for supplying a data signal to each of the data lines, and amounts of light emitted by the light sources in the liquid crystal display apparatus according to the first preferred embodiment of the present invention.

FIG. 5A is a spectrum diagram showing a spectral characteristic of a cold cathode fluorescent tube 31RB, FIG. 5B is a spectrum diagram showing a spectral characteristic of a cold cathode fluorescent tube 31G, FIG. 5C is a spectrum diagram showing a spectral characteristic of light that is transmitted through a pixel corresponding to a red color filter when the cold cathode florescent tubes 31RB are switched on, FIG. 5D is a spectrum diagram showing a spectral characteristic of light that is transmitted through a pixel corresponding to a green color filter when the cold cathode fluorescent tubes 31G are switched on, and FIG. 5E is a spectrum diagram showing a spectral characteristic of light that is transmitted through a pixel corresponding to a blue color filter when the cold cathode fluorescent tubes 31RB are switched on.

FIG. 6 is a chromaticity diagram (NTSC ratio) showing color reproduction ranges in the CIE 1931 color system of a conventional liquid crystal display apparatus using a three-wavelength tube as a light source for a backlight and the liquid crystal display apparatus according to a preferred embodiment of the present invention, respectively.

FIG. 7 is a block diagram showing a functional configuration of a liquid crystal display apparatus according to a second preferred embodiment of the present invention.

FIG. 8 is a timing chart showing one example of timing for switching on each cold cathode fluorescent tube in the liquid crystal display apparatus according to the second preferred embodiment of the present invention.

FIG. 9 is a timing chart showing another example of the timing for switching on each cold cathode fluorescent tube in the liquid crystal display apparatus according to the second preferred embodiment of the present invention.

FIG. 10 is a timing chart showing still another example of the timing for switching on each cold cathode fluorescent tube in the liquid crystal display apparatus according to the second preferred embodiment of the present invention.

FIG. 11 is a block diagram showing a functional configuration of a liquid crystal display apparatus according to a third preferred embodiment of the present invention.

FIG. 12 is a block diagram showing an internal configuration of an interpolation data generating portion provided in the liquid crystal display apparatus according to the third preferred embodiment of the present invention.

FIG. 13 is a plan view showing one example of an arrangement of LEDs used as light sources for a backlight in a liquid crystal display apparatus as a modification example of the first to third preferred embodiments of the present invention.

FIG. 14 is a schematic diagram showing a structure of an active matrix substrate in a conventional active matrix type liquid crystal display element, in which each pixel is shown with a color of color filters corresponding thereto.

FIG. 15 is a spectrum diagram showing spectral transmission characteristics of color filters of three colors of RGB.

FIG. 16A is a spectrum diagram showing an emission spectrum of a three-wavelength tube, FIG. 16B is a spectrum diagram showing a spectral transmission characteristic of a red color filter in the case where this three-wavelength tube is used as a light source for a backlight, FIG. 16C is a spectral diagram showing a spectral transmission characteristic of a green color filter in the case where this three-wavelength tube is used as the light source for the backlight, and FIG. 16D is a spectrum diagram showing a spectral transmission characteristic of a blue color filter in the case where this three-wavelength tube is used as the light source for the backlight.

### DETAILED DESCRIPTION OF THE PREFERRED EMBODIMENTS

The display apparatus according to a preferred embodiment of the present invention includes a display element that includes: scanning lines and data lines that are arranged in a matrix form; a switching element that is connected to each of the scanning lines and a corresponding one of the data lines; a pixel portion that performs a gradation display in accordance with a data signal written from the corresponding one of the data lines when the switching element is brought to an ON state based on a signal of the each of the scanning lines; and color filters that are arranged so as to correspond to the pixel portions and include at least filters of three colors that exhibit a white color when mixed; an illumination device that outputs plane-shaped light to the display element and includes a first light source that emits light of a first color that is one of the three colors and a second light source that emits light of a second color complementary to the first color; a scanning line driving portion that sequentially supplies a selection signal to each of the scanning lines at a cycle of half a time period in which one image is displayed in the display element; a data line driving portion that, at one of a first half and a latter half of the time period in which one image is displayed in the display element, supplies a data signal to be written into each in a group of pixel portions among the pixel portions that corresponds to the color filter of the first color to a corresponding one of the data lines, and at another of the first half and the latter half of the time period, supplies a data signal to be written into each in groups of pixel portions among the pixel portions that correspond respectively to the color filters of two colors among the three colors other than the first color to a corresponding one of the data lines; and a light source driving portion that, at the one of the first half and the latter half of the time period in which one image is displayed in the display element, switches on the first light source while switching off the second light source, and at the other of the first half and the latter half of the time period, switches on the second light source while switching off the first light source.

Herein, the phrase “ . . . exhibit a white color when mixed” refers to a state of being seen to be white and nearly white to the human eye, which does not necessarily have to be a state of exhibiting perfect white (so-called paper white).

According to this configuration, at one of a first half and a latter half of a time period in which one image is displayed in the display element, a data signal to be written into each in a group of pixel portions among the pixel portions that corresponds to the color filter of the first color is supplied to a corresponding one of the data lines, and at another of the first half and the latter half of the time period, a data signal to be written into each in groups of pixel portions among the pixel portions that correspond respectively to the color filters of two colors among the three colors other than the first color to a corresponding one of the data lines. Further, at the one of the first half and the latter half of the time period in which one image is displayed in the display element, the first light source is switched on while the second light source is switched off, and at the other of the first half and the latter half of the time period, the second light source is switched on while the first light source is switched off. Thus, even in the case where a spectral transmission curve of any one of color filters of the respective colors overlaps a wavelength region of another color, deterioration in color purity can be prevented and minimized.

Furthermore, preferably, in the above-described configuration, at one of the first half and the latter half of the time period in which one image is displayed in the display element, the data line driving portion supplies a data signal for causing each in the groups of pixel portions among the pixel portions that correspond respectively to the color filters of two colors among the three colors other than the first color to perform a black gradation display to a corresponding one of the data lines, and at another of the first half and the latter half of the time period in which one image is displayed in the display element, the data line driving portion supplies a data signal for causing each in the group of pixel portions among the pixel portions that corresponds to the color filter of the first color to perform a black display to a corresponding one of the data lines.

This is preferable in that at each of a first half and a latter half of a time period in which one image is displayed in the display element, a pixel portion of a color that is not to be displayed is set so as to perform a black display, and thus the generation of leakage light is prevented, thereby allowing further improved color purity to be obtained.

Furthermore, preferably, in the illumination device in the above-described configuration, a plurality of the first light sources and a plurality of the second light sources are arranged in a direction orthogonal to the scanning lines, and at one of the first half and the latter half of the time period in which one image is displayed in the display element, the light source driving portion switches on the plurality of the first light sources successively in an order of arrangement so as to be synchronized with an application of the selection signal to each of the scanning lines, and at another of the first half and the latter half of the time period in which one image is displayed in the display element, the light source driving portion switches on the plurality of the second light sources successively in an order of arrangement so as to be synchronized with the application of the selection signal to each of the scanning lines.

This configuration is preferable in that with respect to the first light source and the second light source that are arranged in close proximity to each other, it prevents light from the first light source from being mixed with light from the second light source, thereby allowing further improved color purity to be obtained.

Furthermore, preferably, in the above-described configuration, an interpolation data generating portion further is provided that generates a data signal to be supplied to one of the data lines at the latter half of the time period in which one image is displayed in the display element by performing interpolation between a data signal to be supplied to the one of the data lines in the time period and a data signal to be supplied to the one of the data lines in a time period subsequent to the time period. This is preferable in that, particularly, in the case where a moving picture is displayed, the occurrence of a color breaking phenomenon can be prevented.

Furthermore, preferably, in the above-described configuration, the light of the first color has a spectrum principally in a wavelength region of green, and the light of the second color has a spectrum principally in wavelength regions of red and blue. Alternatively, it is also preferable that in the above-described configuration, the light of the first color has a spectrum principally in a wavelength region of blue, and the light of the second color has a spectrum principally in wavelength regions of red and green.

Furthermore, preferably, in the above-described configuration, each of the first light source and the second light source is a cold cathode fluorescent tube or a hot cathode fluorescent tube. Moreover, preferably, in this configuration, a plurality of the first light sources and a plurality of the second light sources are provided and arranged so as to alternate with each other one by one or in sets of a plural number of the first or second light sources.

Furthermore, the above-described configuration may be such that the first light source is a green light-emitting diode, and the second light source is formed of a combination of a red light-emitting diode and a blue light-emitting diode that emits light at a same time that the red light-emitting diode emits light. Alternatively, the above-described configuration also may be such that the first light source is a blue light-emitting diode, and the second light source is formed of a combination of a red light-emitting diode and a green light-emitting diode that emits light at a same time that the red light-emitting diode emits light.

Furthermore, preferably, in the display apparatus having the above-described configuration, the display element is a liquid crystal display element including a liquid crystal layer. This is preferable in that without depending on the field sequential driving, a liquid crystal display apparatus that performs a high quality moving picture display with improved color purity can be realized.

Furthermore, an illumination device according to a preferred embodiment of the present invention is an illumination device that is used as a backlight of a display apparatus. The illumination device includes: a first light source that emits light of a first color; and a second light source that emits light of a second color complementary to the first color, and the first light source and the second light source can be controlled so as to be switched on independently of each other.

Preferably, in the above-described illumination device, the light of the first color has a spectrum principally in a wavelength region of green, and the light of the second color has a spectrum principally in wavelength regions of red and blue. Alternatively, it is also preferable that in the above-described illumination device, the light of the first color has a spectrum principally in a wavelength region of blue, and the light of the second color has a spectrum principally in wavelength regions of red and green.

Preferably, in the above-described illumination device, each of the first light source and the second light source is a cold cathode fluorescent tube or a hot cathode fluorescent tube. Moreover, preferably, a plurality of the first light sources and a plurality of the second light sources are provided and arranged so as to alternate with each other one by one or in sets of a plural number of the first or second light sources.

Furthermore, preferably, in the above-described illumination device, the first light source is a green light-emitting diode, and the second light source is formed of a combination of a red light-emitting diode and a blue light-emitting diode that emits light at a same time that the red light-emitting diode emits light. Alternatively, it is preferable that, in the above-described illumination device, the first light source is a blue light-emitting diode, and the second light source is formed of a combination of a red light-emitting diode and a green light-emitting diode that emits light at a same time that the red light-emitting diode emits light.

Hereinafter, the illumination device and the display apparatus according to the present invention will be described by way of preferred embodiments with reference to the appended drawings. While being directed to an exemplary case where a television receiver including a transmission type liquid crystal display element is used as the display apparatus according to a preferred embodiment of the present invention, the following description is not intended to limit an application scope of the present invention. As the display element according to a preferred embodiment of the present invention, for example, a semi-transmission type liquid crystal display element may preferably be used. Further, the applications of the display apparatus according to a preferred embodiment of the present invention are not limited only to a television receiver.

### First Preferred Embodiment

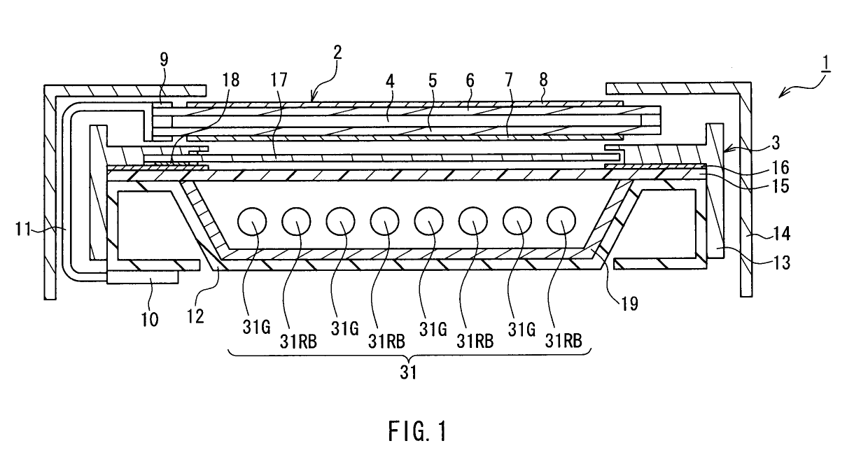

FIG. 1 is a schematic cross-sectional view illustrating an illumination device and a liquid crystal display apparatus provided with the same according to a first preferred embodiment of the present invention. As shown in FIG. 1, in a liquid crystal display apparatus 1 according to this preferred embodiment, a liquid crystal panel 2 (display element) that is located with an upper side of FIG. 1 defined as a viewing side (display surface side) and a backlight device 3 (illumination device) that is disposed on a non-display surface side of the liquid crystal panel 2 (lower side of FIG. 1) and irradiates the liquid crystal panel 2 with plane-shaped light are provided.

The liquid crystal panel 2 includes a liquid crystal layer 4, a pair of transparent substrates 5 and 6 that sandwich the liquid crystal layer 4 therebetween, and polarizing plates 7 and 8 that are provided on the respective outer surfaces of the transparent substrates 5 and 6, respectively. Further, in the liquid crystal panel 2, a driver 9 (a gate driver or a source driver that will be described later) for driving the liquid crystal panel 2 and a drive circuit 10 that is connected to the driver 9 via a flexible printed board 11 are provided.

The liquid crystal panel 2 is an active matrix type liquid crystal panel and is configured so that supplying a scanning signal and a data signal respectively to scanning lines and data lines that are arranged in a matrix form allows the liquid crystal layer 4 to be driven on a pixel basis. Specifically, when a TFT (switching element) provided in the vicinity of each of intersections of the scanning lines and the data lines is brought to an ON state based on a signal of a corresponding one of the scanning lines, a data signal is written from a corresponding one of the data lines into a pixel electrode, and an alignment state of liquid crystal molecules changes in accordance with a potential level of the data signal, and thus each pixel performs a gradation display in accordance with a data signal. In other words, in the liquid crystal panel 2, a polarization state of light made incident from the backlight device 3 through the polarizing plate 7 is modulated by the liquid crystal layer 4, and an amount of light passing through the polarizing plate 8 is controlled, and thus a desired image is displayed.

In the backlight device 3, a case 12 that is open on the liquid crystal panel 2 side and a frame 13 that is located on the liquid crystal panel 2 side of the case 12 are provided. Further, the case 12 and the frame 13 are preferably made of a metal or a synthetic resin and are held within a bezel 14 having an L shape in cross section with the liquid crystal panel 2 located above the frame 13. The backlight device 3 thus is combined with the liquid crystal panel 2, and the backlight device 3 and the liquid crystal panel 2 are integrated as the liquid crystal display apparatus 1 of a transmission type in which illumination light from the backlight device 3 is made incident on the liquid crystal panel 2.

Furthermore, the backlight device 3 includes a diffusing plate 15 that is arranged so as to cover an opening of the case 12, an optical sheet 17 that is located above the diffusing plate 15 on the liquid crystal panel 2 side, and a reflecting sheet 19 that is provided on an inner surface of the case 12. Further, in the backlight device 3, a plurality of cold cathode fluorescent tubes 31 are provided above the reflecting sheet 19, and light from these cold cathode fluorescent tubes 31 is irradiated toward the liquid crystal panel 2 as plane-shaped light. Although FIG. 1 shows, for the sake of simplicity, a configuration including eight cold cathode fluorescent tubes 31, the number of the cold cathode fluorescent tubes 31 is not limited thereto.

These plurality of cold cathode fluorescent tubes 31 include a cold cathode fluorescent tube 31G in which a green phosphor (for example, NP-108 manufactured by Nichia Corporation) is sealed so that an emission spectrum of the cold cathode fluorescent tube 31G has a peak in a wavelength region of green (for example, in the vicinity of 516 nm) and a cold cathode tube 31RB in which red and blue phosphors (for example, NP-320 and NP-103 manufactured by Nichia Corporation) are sealed so that an emission spectrum of the cold cathode tube 31RB has peaks in a wavelength region of red (for example, in the vicinity of 658 nm) and in a wavelength region of blue (for example, in the vicinity of 447 nm), respectively.

The cold cathode tubes 31G and 31RB are arranged so that a longitudinal direction thereof is parallel or substantially parallel to an extending direction of the scanning lines of the liquid crystal panel 2. Although FIG. 1 shows an example in which the cold cathode fluorescent tubes 31G and the cold cathode fluorescent tubes 31RB are arranged so as to alternate with each other one by one, the cold cathode fluorescent tubes 31G and the cold cathode fluorescent tubes 31RB also may be arranged so as to alternate with each other in sets of a plural number (for example, two) of the cold cathode fluorescent tubes 31G or 31RB.

The number of the cold cathode fluorescent tubes 31 is set suitably in accordance with the screen size of the liquid crystal display apparatus 1, the brightness of each type of the fluorescent tubes, a desired color balance and the like. As one example, in the case where the liquid crystal display apparatus 1 has a screen size of a so-called 37V type and uses, as described above, the cold cathode fluorescent tube 31G having an emission peak in a wavelength region of green (in the vicinity of 516 nm) and the cold cathode tube 31RB having peaks in a wavelength region of red (in the vicinity of 658 nm) and in a wavelength region of blue (in the vicinity of 447 nm), respectively, in order to realize a white display, it is preferable to have a configuration that includes about 18 cold cathode fluorescent tubes in total composed of four cold cathode fluorescent tubes 31G and 14 cold cathode fluorescent tubes 31RB. In this case, in consideration of variations in lamp illumination, the number of the cold cathode fluorescent tubes 31G may be set to five to six so that a lamp current value is decreased.

The diffusing plate 15 that is made of, for example, a synthetic resin or a glass material diffuses light from the cold cathode fluorescent tubes 31 (containing light reflected off the reflecting sheet 19) and outputs it to the optical sheet 17 side. Further, the four sides of the diffusing plate 15 are mounted on a frame-shaped surface provided on an upper side of the case 12, and the diffusing plate 15 is incorporated in the backlight device 3 while being sandwiched between the surface of the case 12 and an inner surface of the frame 13 via a pressure member 16 that is deformable elastically.

The optical sheet 17 includes a condensing sheet formed of, for example, a synthetic resin film and is configured so as to increase the luminance of illumination light from the backlight device 3 to the liquid crystal panel 2. Further, on the optical sheet 17, optical sheet materials such as a prism sheet, a diffusing sheet, a polarizing sheet and the like are laminated suitably as required for the purpose of, for example, improving display quality on a display surface of the liquid crystal panel 2. The optical sheet 17 is configured so as to convert light outputted from the diffusing plate 15 into plane-shaped light having a uniform luminance not lower than a predetermined luminance (for example, 10,000 cd/m²) and make it incident as illumination light on the liquid crystal panel 2. In addition to the above-described configuration, for example, optical members such as a diffusing sheet and the like for adjusting a viewing angle of the liquid crystal panel 2 may be laminated suitably above the liquid crystal panel 2 (on the display surface side).

The reflecting sheet 19 is preferably formed of, for example, a thin film of a metal having a high light reflectance such as aluminum, silver or the like and functions as a reflecting plate that reflects light from the cold cathode fluorescent tubes 31 toward the diffusing plate 15. Thus, in the backlight device 3, the use efficiency and luminance at the diffusing plate 15 of light from the cold cathode fluorescent tubes 31 can be increased. In place of the above-described metal thin film, a reflecting sheet material made of a synthetic resin may be used, or alternatively, for example, a coating of a white paint or the like having a high light reflectance may be applied to the inner surface of the case 12 so that said inner surface functions as a reflecting plate.

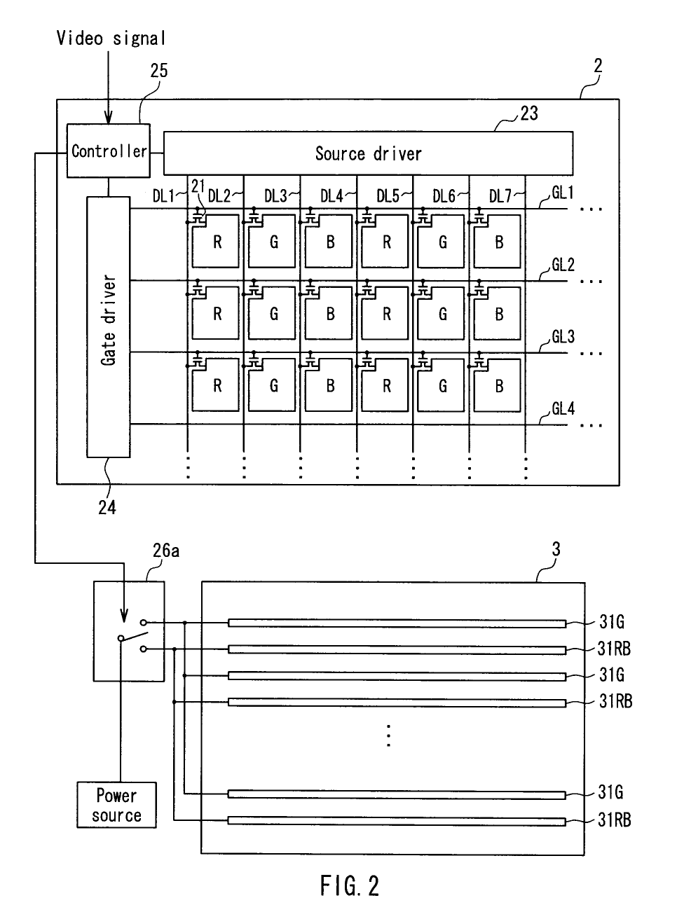

In the following, the configurations of the liquid crystal panel 2 and the backlight device 3 in the liquid crystal display apparatus 1 and methods of driving them will be described in more detail with reference to FIG. 2. FIG. 2 is a diagram schematically showing a functional relationship between the liquid crystal panel 2 and the backlight device 3 but is not intended to faithfully represent the physical sizes of the liquid crystal panel 2 and the backlight device 3.

As described above, the liquid crystal panel 2 preferably is an active matrix type liquid crystal display element, and as shown in FIG. 2, it includes scanning lines GL and data lines DL that are arranged in a matrix form, a TFT 21 that is disposed at each of intersections of the scanning lines GL and the data lines DL, a pixel electrode 22 that is connected to a drain electrode of the TFT 21, a gate driver 24 that sequentially supplies a selection signal to the scanning lines GL, a source driver 23 that supplies a data signal to each of the data lines, and a controller 25 that supplies a clock signal, a timing signal and the like to the source driver 23, the gate driver 24 and the like.

Furthermore, the liquid crystal display apparatus 1 includes a switch circuit 26 that controls switching on/off of the cold cathode fluorescent tubes 31G and 31RB of the backlight device 3 in accordance with, for example, a timing signal supplied from the controller 25. The switch circuit 26 controls switching on/off of the cold cathode fluorescent tubes 31G and 31RB through ON/OFF of voltage supply from an alternating-current power source or the like to the cold cathode fluorescent tubes 31G and 31IRB. In this preferred embodiment, the switch circuit 26 is configured so that ON/OFF of all the plurality of the cold cathode fluorescent tubes 31G are controlled simultaneously, and ON/OFF of all the plurality of the cold cathode fluorescent tubes 31RB also are controlled simultaneously.

The configurations of the drivers and controller shown in FIG. 2 are merely illustrative, and modes of mounting these driving system circuits are arbitrary. For example, these driving system circuits may be provided so that at least part of them is formed monolithically on an active matrix substrate, also may be mounted as semiconductor chips on a substrate, or alternatively, may be connected as external circuits of the active matrix substrate. Further, the switch circuit 26 may be provided on either of the liquid crystal panel 2 and the backlight device 3.

On an opposing substrate (not shown) opposed to this active matrix substrate, color filter layers of three colors of RGB are formed in stripes. In FIG. 2, the colors of the color filters corresponding respectively to pixels are denoted by characters “R”, “G”, and “B”. Thus, as shown in FIG. 2, all of pixels in one column connected commonly to each of the data lines DL display one of the colors of RGB. For example, in FIG. 2, all of pixels connected to the data line DL1 display red. Although the color filters described herein are in a stripe arrangement, other types of arrangements such as a delta arrangement and the like also may be adopted.

In the liquid crystal panel 2 configured as above, when a gate pulse (selection signal) having a predetermined voltage is applied sequentially to the scanning lines GL1, GL2, GL3, GL4, . . . , each of the TFTs 21 connected to one of the scanning lines GL, to which the gate pulse has just been applied, is brought to an ON state, and a value of a gradation voltage that has been applied to a corresponding one of the data lines DL at that point in time is written into the each of the TFTs 21. Consequently, a potential of the pixel electrode 22 connected to a drain electrode of the each of the TFTs 21 becomes equal to the value of the gradation voltage of the corresponding one of the data lines DL. As a result of this, an alignment of liquid crystals interposed between the pixel electrode 22 and an opposing electrode changes in accordance with the value of the gradation voltage, and thus a gradation display of said pixel is realized. On the other hand, during a time period in which a non-selective voltage is applied to the scanning lines GL, the TFTs 21 are brought to an OFF state, so that the potential of the pixel electrode 22 is maintained at a value of a potential applied thereto at the time of writing.

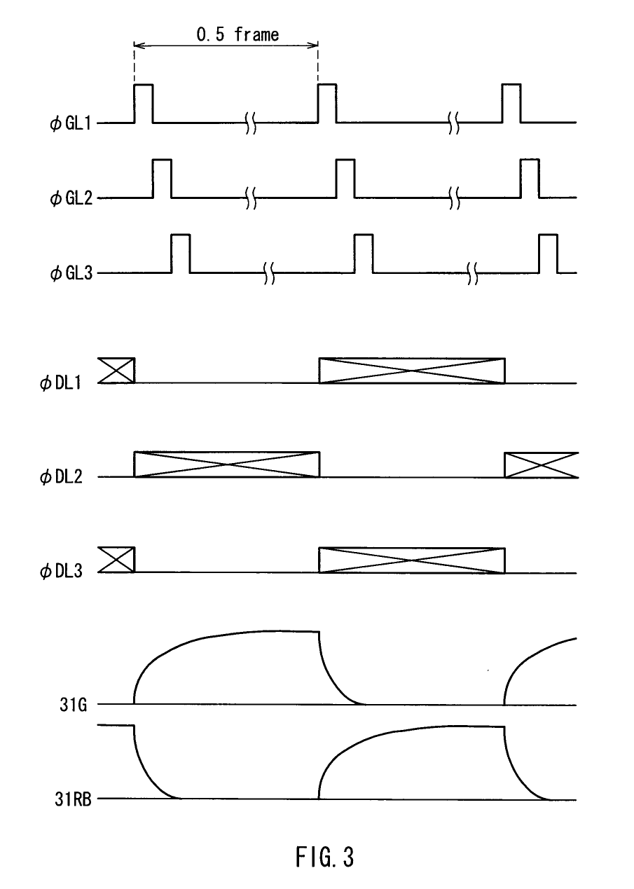

In the liquid crystal display apparatus 1 according to this preferred embodiment, which is configured as above, as shown in FIG. 3, the gate driver 24 applies a gate pulse to each of the scanning lines GL at a cycle of ½ of a time period (one frame time period) in which one image is displayed in the liquid crystal panel 2. Then, at a first half of this one frame time period, the switch circuit 26 switches on the cold cathode fluorescent tubes 31G that emit green light while switching off the cold cathode fluorescent tubes 31RB. Further, at a latter half of one frame time period, the switch circuit 26 switches off the cold cathode fluorescent tubes 31G that emit green light while switching on the cold cathode fluorescent tubes 31RB. In FIG. 3, the first and second graphs from the bottom show amounts of light emitted by the cold cathode fluorescent tubes 31G and 31RB, respectively.

Furthermore, at the first half of one frame time period, the source driver 23 supplies a data signal to be applied to a green pixel to each of the data lines DL2, DL5, DL8, . . . that are connected to a group of pixel electrodes 22 among of the pixel electrodes 22 that corresponds to the green color filter. Thus, at the first half of one frame time period, only a portion constituted of green pixels in one image is displayed.

Furthermore, at the latter half of one frame time period, the source driver 23 supplies a data signal to be applied to a red pixel to each of the data lines DL1, DL4, DL7, . . . that are connected to a group of pixel electrodes 22 among the pixel electrodes 22 that corresponds to the red color filter, and supplies a data signal to be applied to a blue pixel to each of the data lines DL3, DL6, DL9, . . . that are connected to a group of pixel electrodes 22 among the pixel electrodes 22 that corresponds to the blue color filter. Thus, at the first half of one frame time period, only portions constituted of red pixels and blue pixels in one image are displayed.

For example, in the case where a data signal is a video signal according to the NTSC standards, the refreshing rate is 60 Hz and the length of one frame time period is about 16.7 seconds. Therefore, in the case where at a first half of one frame time period, only a portion constituted of green pixels is displayed, and at a latter half thereof, portions constituted of red pixels and blue pixels are displayed as described above, due to a residual image effect, a resulting image is recognized to the human eye as an image of mixed colors of the three primary colors.

At the first half of one frame time period, during lighting of the cold cathode fluorescent tubes 31G that emit green light, a data signal supplied to each of the data lines DL1, DL4, DL7, . . . that are connected to the group of pixel electrodes 22 among the pixel electrodes 22 that corresponds to the red color filter and a data signal supplied to each of the data lines DL3, DL6, DL9, . . . that are connected to the group of pixel electrodes 22 among the pixel electrodes 22 that corresponds to the blue color filter may be maintained at a value of a potential applied in an immediately preceding frame or may have a predetermined potential value. However, it is preferable that these data signals have such a potential value as to cause a black display. This is preferable because a black display allows unwanted leakage light from a pixel portion to be blocked. The following describes reasons why leakage light as described above is generated.

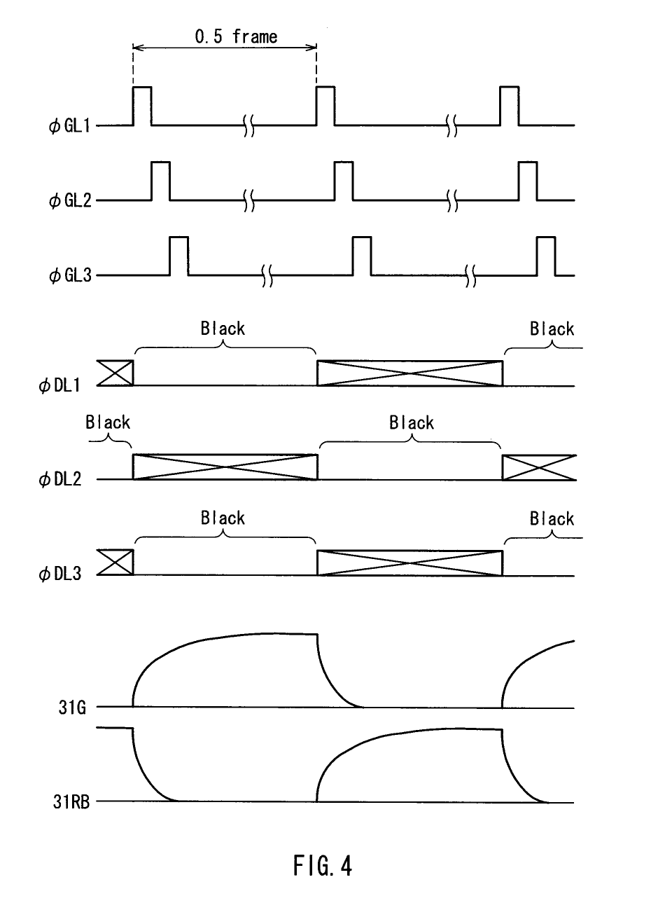

One possible reason is that an ON/OFF signal of a drive circuit of the cold cathode fluorescent tubes is delayed or dull. That is, when the switch circuit 26 is controlled so that switching on/off is switched depending on whether the switching is performed at a first half or a latter half of one frame time period, if an ON/OFF signal is delayed or dull, there occurs a deviation of timing at which the cold cathode fluorescent tubes actually are switched ON/OFF. Because of this, for example, at an early stage of a first half of a frame, due to light from the cold cathode fluorescent tubes 31RB that are supposed to have been switched off, leakage light from the red and blue pixels may be generated, though in a small amount. Further, reasons other than the above-described reason include an ON/OFF delay of the cold cathode fluorescent tubes. Specifically, a cold cathode fluorescent tube has a characteristic that an amount of light emitted thereby does not immediately change in response to the control of switching on/off. For example, as shown in FIG. 4, when the switch circuit 26 is controlled so that switching on/off is switched depending on whether the switching is performed at a first half or a latter half of one frame time period, with respect to either of the cold cathode fluorescent tube 31G and the cold cathode fluorescent tube 31RB, which is being switched off, an amount of light emitted thereby does not become zero immediately after switching via the switch circuit 26. Because of this, for example, at an early stage of a first half of a frame, due to light from the cold cathode fluorescent tubes 31RB that are supposed to have been switched off, leakage light from the red and blue pixels may be generated, though in a small amount.

In such a case, as shown in FIG. 4, at a first half of one frame time period, a data signal having such a potential value as to cause a black display is applied to each of the data lines DL1, DL4, DL7, . . . that are connected to the group of pixel electrodes 22 among the pixel electrodes 22 that corresponds to the red color filter and to each of the data lines DL3, DL6, DL9, . . . that are connected to the group of pixel electrodes 22 among the pixel electrodes 22 that corresponds to the blue color filter, and thus the generation of leakage light as described above can be prevented, thereby allowing further improved color purity to be obtained. For the same reason, it is preferable that, at a latter half of one frame time period, a data signal having such a potential value as to cause a black display is supplied to each of the data lines DL2, DL5, DL8, . . . that are connected to the group of pixel electrodes 22 among the pixel electrodes 22 that corresponds to the green color filter.

Herein, the description is directed to an effect provided by the configuration according to this preferred embodiment in comparison with the conventional technique.

As shown in FIGS. 16C and 16D, the conventional configuration using a three-wavelength tube or a four-wavelength tube as a light source for a backlight has presented a problem that a blue component is mixed into a pixel that is to be displayed in green, and a green component is mixed into a pixel that is to be displayed in blue. This is caused by the fact that a spectral transmission curve of a blue color filter partially overlaps a wavelength band region of green and a spectral transmission curve of a green color filter partially overlaps a wavelength band region of blue. Particularly, the human eye has high sensitivity to a wavelength component of green, so that an adverse effect exerted on image quality when a green component is mixed into a blue pixel has been recognized to be considerable.

With respect to this problem, in the configuration according to this preferred embodiment, when displaying pixels corresponding to the blue color filter, only the cold cathode fluorescent tubes 31RB that do not have a wavelength component of green are switched on, and thus even though a spectral transmission curve of a blue color filter partially overlaps a wavelength band region of green, there is no possibility that an emission spectrum occurs in the wavelength region of green, thereby preventing the occurrence of color mixing. This achieves an improvement in color purity.

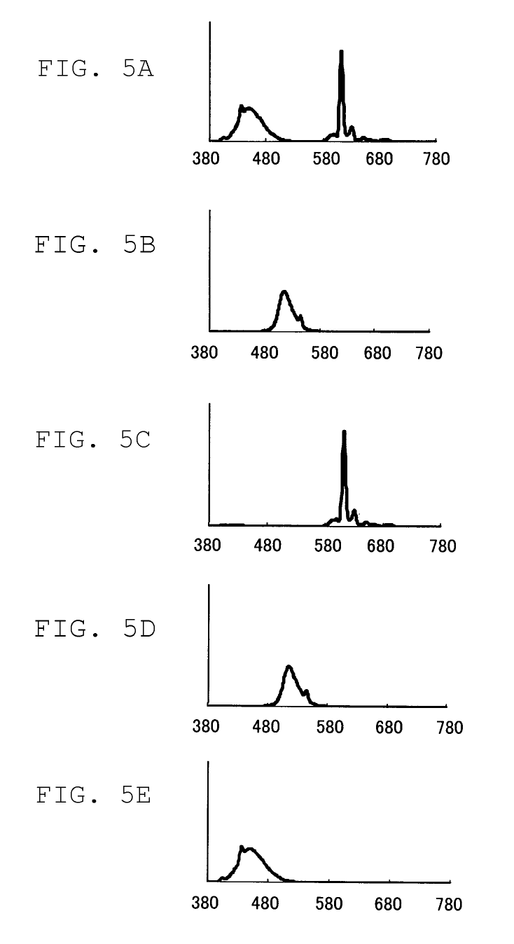

Particularly, by the above-described configuration in which the red and blue pixels are set so as to perform a black display during a time period (first half of one frame) in which the green pixels are displayed and the green pixels are set so as to perform a black display during a time period (latter half of one frame) in which the red and blue pixels are displayed, red, green, and blue can be separated completely without being mixed as shown in FIGS. 5C to 5E. FIG. 5A is a spectrum diagram showing a spectral characteristic of the cold cathode fluorescent tube 31RB, and FIG. 5B is a spectrum diagram showing a spectral characteristic of the cold cathode fluorescent tube 31G. FIG. 5C is a spectrum diagram showing a spectral characteristic of light that is transmitted through a pixel corresponding to the red color filter when the cold cathode fluorescent tubes 31RB are switched on. FIG. 5D is a spectrum diagram showing a spectral characteristic of light that is transmitted through a pixel corresponding to the green color filter when the cold cathode fluorescent tubes 31G are switched on. FIG. 5E is a spectrum diagram showing a spectral characteristic of light that is transmitted through a pixel corresponding to the blue color filter when the cold cathode fluorescent tubes 31RB are switched on.

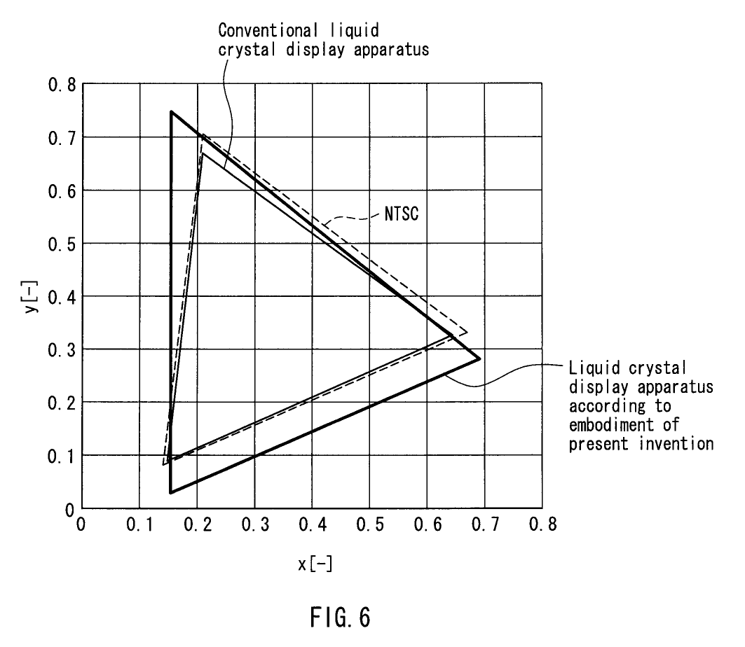

FIG. 6 is a chromaticity diagram (NTSC ratio) showing color reproduction ranges in the CIE 1931 color system of a conventional liquid crystal display apparatus using a three-wavelength tube as a light source for a backlight and the liquid crystal display apparatus according to this preferred embodiment. As the three-wavelength tube used as the light source for the backlight in the conventional liquid crystal display apparatus, a fluorescent tube was used in which a phosphor having an emission spectrum in a wavelength region of green (in the vicinity of 516 nm) (NP-108 manufactured by Nichia Corporation), a phosphor having an emission spectrum in a wavelength region of red (in the vicinity of 611 nm) (NP-340 manufactured by Nichia Corporation), and a phosphor having an emission spectrum in a wavelength region of blue (in the vicinity of 450 nm) (NP-107 manufactured by Nichia Corporation) were sealed.

As can be seen from FIG. 6, compared with the conventional liquid crystal display apparatus, the liquid crystal display apparatus according to this preferred embodiment exhibits highly improved color purity. As for a NTSC ratio, the conventional liquid crystal display apparatus had a ratio of 87.4%, whereas the liquid crystal display apparatus according to this preferred embodiment had a ratio of about 121.3%.

As discussed in the foregoing description, according to the liquid crystal display apparatus of this preferred embodiment, compared with a conventional liquid crystal display apparatus using a three-wavelength tube or a four-wavelength tube as a light source for a backlight, improved color purity can be obtained. Further, although a supply of a gate pulse at a cycle of 0.5 frames increases a refreshing rate of a screen, since liquid crystals have a response speed that can conform to the refreshing rate at a frame rate of NTSC, PAL or the like, the liquid crystal display apparatus according to this preferred embodiment still can be realized sufficiently.

### Second Preferred Embodiment

The following describes an illumination device and a liquid crystal display apparatus provided with the same according to a second preferred embodiment of the present invention. In the following description, configurations having functions similar to those of the configurations described in the first preferred embodiment are denoted by the same reference characters, and duplicate descriptions thereof are omitted.

The liquid crystal display apparatus according to this preferred embodiment is deferent from the liquid crystal display apparatus according to the first preferred embodiment in that cold cathode fluorescent tubes 31G of a backlight device 3 are switched on successively in an order of arrangement so as to be synchronized with scanning of scanning lines in a liquid crystal panel 2, and so are cold cathode fluorescent tubes 31RB of the backlight device 3. In this preferred embodiment, in a similar manner to the first preferred embodiment, at a first half of one frame time period, a data signal is supplied to each in a group of data lines DL among data lines DL, which are connected to green pixels, and at a latter half of one frame time period, a data signal is supplied to each in a group of data lines DL among the data lines DL, which are connected to red pixels and data signal is supplied to each in a group of data lines DL among the data lines DL, which are connected to blue pixels.

Herein, the above-described expression “so as to be synchronized” means that in a 0.5 frame time period, the cold cathode fluorescent tubes 31G or the cold cathode fluorescent tubes 31RB are switched on sequentially from an upper side toward a lower side of a screen of the liquid crystal panel 2 so as to substantially track each one of scanning lines GL selected sequentially from the upper side toward the lower side of the screen of the liquid crystal panel 2, and does not necessarily require that timing for selecting the scanning lines GL be matched precisely with timing for switching on the cold cathode fluorescent tubes 31.

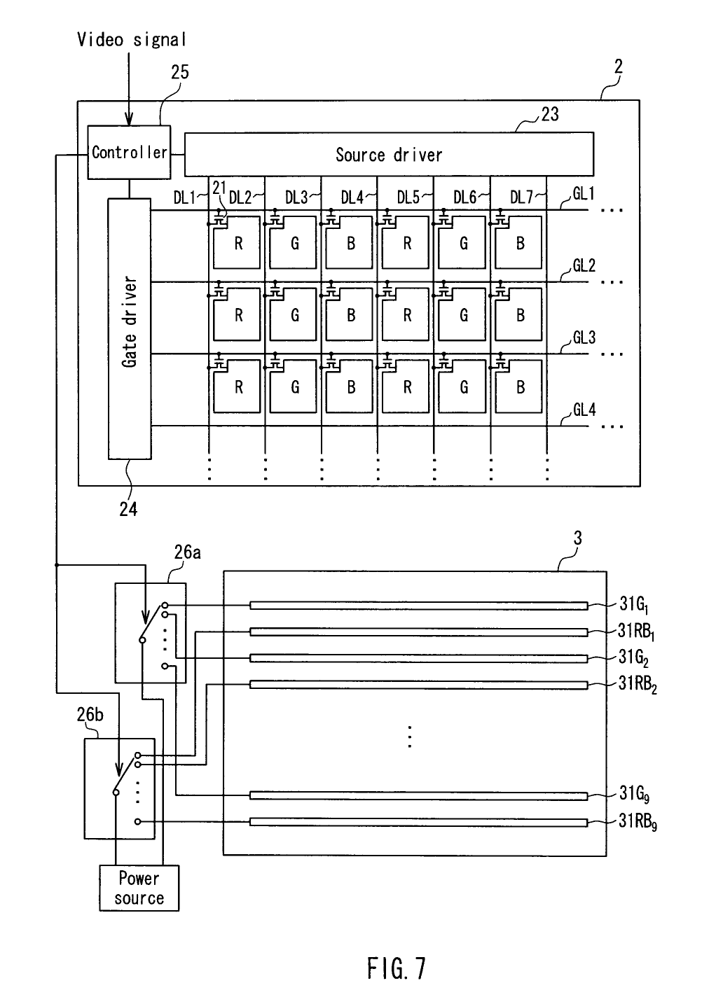

Therefore, as shown in FIG. 7, a liquid crystal display apparatus 20 according to this preferred embodiment includes, in place of the switch circuit 26 in the liquid crystal display apparatus 1 according to the first preferred embodiment, a switch circuit 26a that controls switching on/off of the cold cathode fluorescent tubes 31G and a switch circuit 26b that controls switching on/off of the cold cathode fluorescent tubes 31RB. In the following description, it is assumed that the liquid crystal display apparatus 20 includes 18 cold cathode fluorescent tubes in total composed of the cold cathode fluorescent tubes 31G₁ to 31G₉ and the cold cathode fluorescent tubes 31RB₁ to 31RB₉.

At a first half of one frame time period, the switch circuit 26a switches on the cold cathode fluorescent tubes 31G₁ to 31G₉ one by one in this order in accordance with, for example, a timing signal supplied from a controller 25 of the liquid crystal panel 2. That is, in a period of 0.5 frames, the cold cathode fluorescent tubes 31G₁ to 31G₉ are switched on one by one in order from the upper side toward the lower side of the screen of the liquid crystal panel 2 (from an upper side toward a lower side of FIG. 7). In a period of 0.5 frames, the scanning lines GL in the liquid crystal panel 2 are selected in order also in a direction from the upper side toward the lower side of the screen. Thus, at the first half of one frame time period, a position in the liquid crystal panel 2 that generally corresponds to one of the scanning lines GL to which a selection signal is being applied is irradiated with light from a corresponding one of the cold cathode fluorescent tubes 31G.

Furthermore, at a latter half of one frame time period, the switch circuit 26b switches on the cold cathode fluorescent tubes 31RB₁ to 31RB₉ one by one in this order in accordance with, for example, a timing signal supplied from the controller 25 of the liquid crystal panel 2. That is, in a period of 0.5 frames, the cold cathode fluorescent tubes 31 RB₁ to 31RB₉ are switched on one by one in order from the upper side toward the lower side of the screen of the liquid crystal panel 2 (from the upper side toward the lower side of FIG. 7). In a period of 0.5 frames, the scanning lines GL in the liquid crystal panel 2 are selected in order also in the direction from the upper side toward the lower side of the screen. Thus, at the latter half of one frame time period, a position in the liquid crystal panel 2 that generally corresponds to one of the scanning lines GL to which a selection signal is being applied is irradiated with light from a corresponding one of the cold cathode fluorescent tubes 31RB.

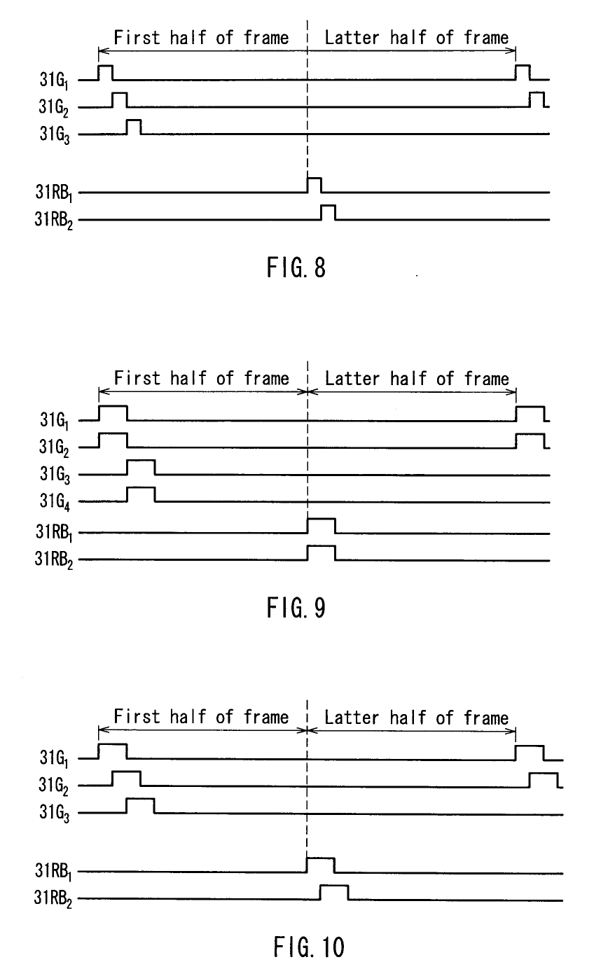

As a result of the above-described control performed by the switch circuits 26a and 26b, as shown in FIG. 8, in one frame time period, the cold cathode fluorescent tubes 31B and 31RB are switched on in an order of 31G₁, 31G₂, 31G₃, . . . 31G₉, 31RB₁, 31RB₂, 31RB₃, . . . 31RB₉. Even though a cold cathode fluorescent tube has a characteristic that an amount of light emitted thereby does not immediately change in response to the control of switching on/off as described above, in this embodiment, there is no possibility that light is emitted simultaneously by any combination of one of the cold cathode fluorescent tubes 31G and one of the cold cathode fluorescent tubes 31RB that are positioned in close proximity to each other. For example, in the case of a combination of the cold cathode fluorescent tube 31G₁ and the cold cathode fluorescent tube 31RB₁ adjacent thereto, the cold cathode fluorescent tube 31RB₁ is switched on after a lapse of about 0.5 frame time period from the time when the cold cathode fluorescent tube 31G₁ is switched off. Thus, there is no possibility that light from the cold cathode fluorescent tube 31G₁ is mixed into light from the cold cathode florescent tube 31RB₁. This allows further improved color purity to be obtained.

Furthermore, similarly to the liquid crystal display apparatus 1 according to the first preferred embodiment, also in the liquid crystal display apparatus 20 according to this preferred embodiment, at a first half of one time frame period, during lighting of the cold cathode fluorescent tubes 31 that emit green light, a data signal supplied to each of the data lines DL1, DL4, DL7, . . . that are connected to a group of pixel electrodes 22 among pixel electrodes 22 that corresponds to a red color filter and a data signal supplied to each of the data lines DL3, DL6, DL9, . . . that are connected to a group of pixel electrodes 22 among the pixel electrodes 22 that corresponds to a blue color filter may be maintained at a value of a potential applied in an immediately preceding frame, may have a predetermined potential value, or alternatively, may have such a potential value as to cause a black display.

Similarly, at a latter half of one frame time period, during lighting of the cold cathode fluorescent tubes 31RB, a data signal supplied to each of the data lines DL2, DL5, DL8, . . . that are connected to a group of pixel electrodes 22 among the pixel electrodes 22 that corresponds to a green color filter may be maintained at a value of a potential applied in an immediately preceding frame, may have a predetermined potential value, or alternatively, may have such a potential value as to cause a black display.

In the foregoing description, the cold cathode fluorescent tubes 31G₁ to 31G₉ and the cold cathode fluorescent tubes 31RB₁ to 31RB₉ were preferably set so as to be switched on one by one sequentially at a first half and a latter half of one frame time period, respectively. However, as long as light is not emitted simultaneously by one of the cold cathode fluorescent tubes 31G and one of the cold cathode fluorescent tubes 31RB that are positioned in close proximity to each other, the effect of preventing the occurrence of color mixing can be obtained. From this viewpoint, the following configurations also are possible as modification examples.

For example, the switch circuits 26a and 26b may be configured so that, as shown in FIG. 9, at a first half of one frame time period, the cold cathode fluorescent tubes 31G₁ to 31G₉ are switched on sequentially in sets of two or more adjacent ones as one set, and at a latter half of one frame time period, the cold cathode fluorescent tubes 31RB₁ to 31RB₉ also are driven to be switched on similarly to the above-described manner. Further, the switch circuits 26a and 26b also may be configured so that, as shown in FIG. 10, the cold cathode fluorescent tubes are switched on sequentially so that the respective periods of lighting time thereof overlap.

### Third Preferred Embodiment

The following describes an illumination device and a liquid crystal display apparatus provided with the same according to a third preferred embodiment of the present invention. In the following description, configurations having functions similar to those of the configurations described in each of the above-described embodiments are denoted by the same reference characters, and duplicate descriptions thereof are omitted.

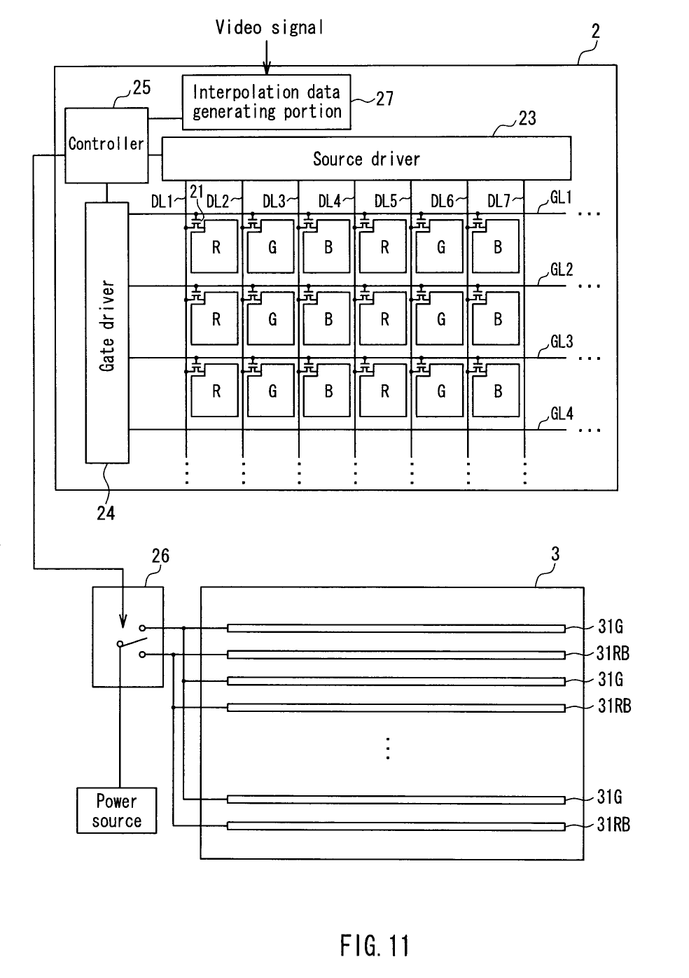

A liquid crystal display apparatus 30 according to this preferred embodiment is different from the first embodiment in that, as shown in FIG. 11, it further includes a interpolation data generating portion 27 that generates a data signal to be supplied to one of data lines DL at a latter half of one frame time period by performing interpolation between a data signal to be supplied to the one of data lines DL in said frame time period and a data signal to be supplied to the one of data lines DL in a frame time period subsequent to said frame time period.

Similarly to the liquid crystal display apparatus 1 according to the first preferred embodiment, in the liquid crystal display apparatus 30 according to this preferred embodiment, at a first half of one frame time period, cold cathode fluorescent tubes 31G are switched on, while cold cathode fluorescent tubes 31RB are switched off, and at a latter half thereof, the cold cathode fluorescent tubes 31RB are switched on, while the cold cathode fluorescent tubes 31G are switched off.

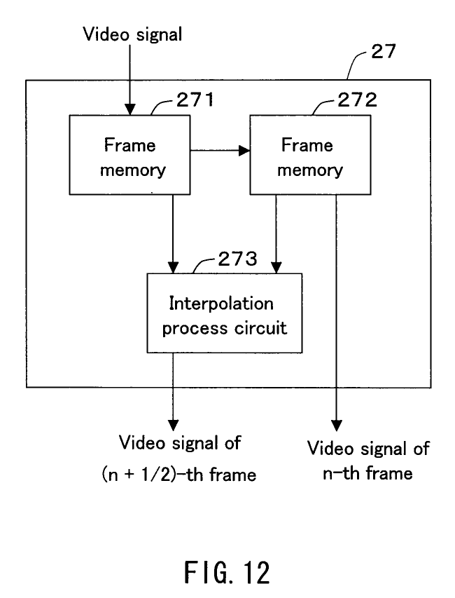

FIG. 12 is a block diagram showing an internal configuration of the interpolation data generating portion 27. As shown in FIG. 12, the interpolation data generating portion 27 includes frame memories 271 and 272 and an interpolation process circuit 273. One frame of a video signal is stored in each of the frame memories 271 and 272.

In the case where a video signal of a n-th frame is stored in the frame memory 271, when a video signal of a succeeding (n+1)-th frame is newly inputted to the interpolation data generating portion 27, the video signal of the n-th frame that has been stored in the frame memory 271 is transferred to the frame memory 272 to be stored in the frame memory 272. After that, the above-described newly inputted video signal of the (n+1)-th frame is stored in the frame memory 271. Therefore, it follows that two frames of video signals in total are stored respectively in the frame memories 271 and 272.

The interpolation process circuit 273 reads out the video signal of the n-th frame and the video signal of the (n+1)-th frame and generates a video signal corresponding to a (n+½)-th frame by an interpolation process. In the interpolation process performed by the interpolation process circuit 273, various well-known algorithms can be used, though descriptions thereof are omitted herein.

The video signal corresponding to the (n+½) frame generated by the interpolation process circuit 273 and the video signal of the n-th frame stored in the frame memory 272 are supplied to a source driver 23 via a controller 25.

At a first half of the n-th frame, the source driver 23 supplies a data signal of a green component of the video signal of the n-th frame to each in a group of data lines DL among the data lines DL, which are connected to green pixels, and at a latter half of the n-th frame, the source driver 23 supplies a data signal of a red component of the video signal corresponding to the (n+½) frame generated by the interpolation process circuit 273 to each in a group of data lines DL among the data lines DL, which are connected to red pixels and supplies a data signal of a blue component of the same video signal corresponding to the (n+½) frame to each in a group of data lines DL among the data lines DL, which are connected to blue pixels.

According to the above-described configuration, particularly, in the case where a moving picture is displayed, the occurrence of a color breaking (referred to also as color breakup) phenomenon can be reduced, which is caused due to images of the primary colors being separated in chronological order when displayed.

FIG. 11 shows an exemplary configuration including, similarly to the liquid crystal display apparatus 1 according to the first preferred embodiment, a switch circuit 26 that, at a first half of one frame time period, switches on the cold cathode fluorescent tubes 31G while switching off the cold cathode fluorescent tubes 31RB, and at a latter half thereof, switches on the cold cathode fluorescent tubes 31RB while switches off the cold cathode fluorescent tubes 31G. However, a configuration also may be adopted in which in place of this switch circuit 26, the switch circuits 26a and 26b described in the second embodiment are provided.

The configurations described in each of the above-described preferred embodiments are merely illustrative, and without limiting the technical scope of the present invention to the above-described specific examples, they can be modified variously.

For example, although each of the above-described preferred embodiments showed an example using a cold cathode fluorescent tube as a light source for a backlight, in place thereof, a hot cathode fluorescent tube also can be used. Further, phosphors presented specifically in the preferred embodiments are no more than illustrative.

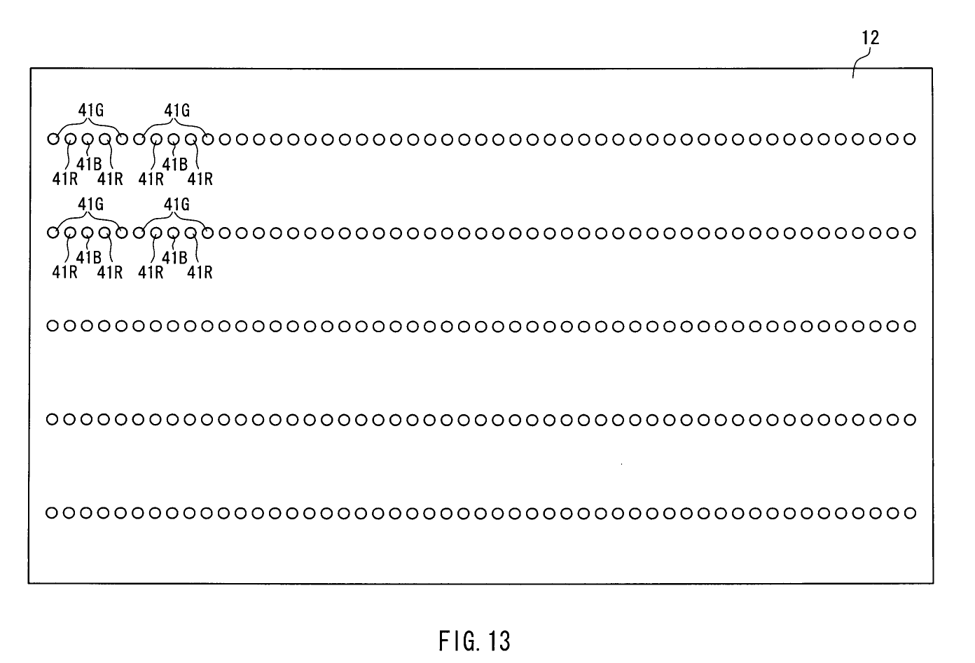

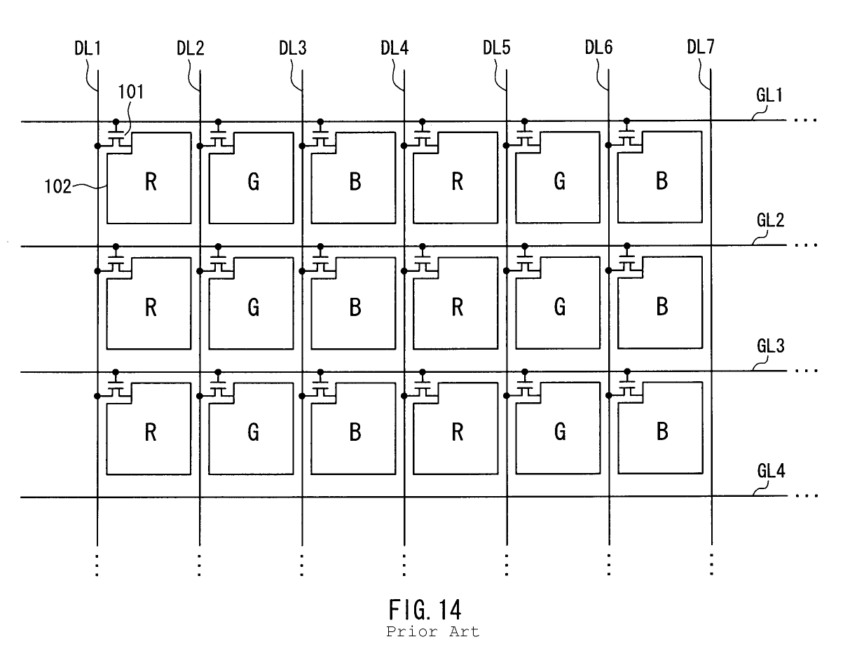

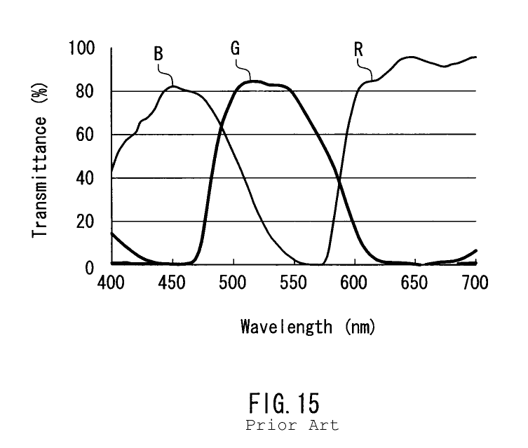

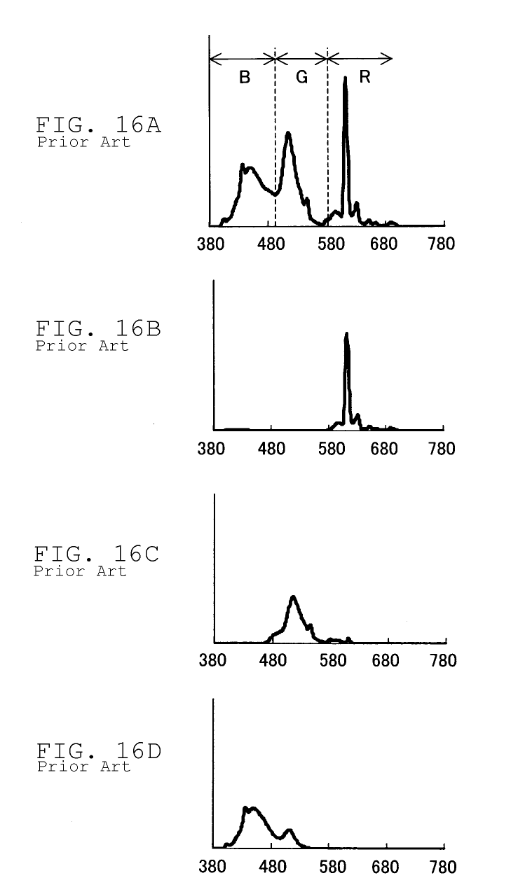

Moreover, it also is possible to use a LED as a light source for the backlight device 3. In that case, a configuration could be adopted in which, in place of the cold cathode fluorescent tubes 31, as shown in FIG. 13, LEDs 41R, 41G, and 41B of the respective colors of RGB are arranged in an orderly manner on a bottom surface of the case 12 of the backlight device 3 (see FIG. 1). This configuration could be such that, at a first half of one frame time period, only the green LEDs 41G are switched on, while the red LEDs 41R and the blue LEDs 41B are switched off, and at a latter half of one frame time period, the red LEDs 41R and the blue LEDs 41B are switched on, while the green LEDs 41G are switched off.

In the case where the LEDs of the respective colors are used as light sources for the backlight device 3 as shown in FIG. 13, it is preferable that, for example, in a liquid crystal display apparatus having a screen size of the 37V type, about 305 LEDs are used in total. In this case, the power consumption of the backlight device 3 would be about 246 W. Although FIG. 13 shows an example with a configuration in which the LEDs 41R, 41G, and 41B of the respective colors of RGB are arranged in an orderly manner in repeated sets of five LEDs composed of LEDs 41G, 41R, 41B, 41R, and 41G, the arrangement and number of the LEDs of the respective colors are not limited only to this example.

Furthermore, in the case of using LEDs in place of the cold cathode fluorescent tubes 31, a configuration may be adopted in which an LED 42 on which light-emitting elements of the respective colors of RGB are mounted as one package is disposed on the bottom surface of the case 12 of the backlight device 3 (see FIG. 1). Also in this LED 42, the light-emitting elements of the respective colors of RGB can be controlled so that the light-emitting elements of one color are switched on/off independently of the light-emitting elements of other colors, and therefore, this configuration could be such that, at a first half of one frame time period, only green light-emitting elements 42G are switched on, while red light-emitting elements 42R and blue light-emitting elements 42B are switched off, and at a latter half of one frame time period, the red light-emitting elements 42R and the blue light-emitting elements 42B are switched on, while the green light-emitting elements 42G are switched off. In the case of using the LED 42 having the above-described configuration as a light source for the backlight device 3, for example, in a liquid crystal display apparatus having a screen size of the 37V type, it is preferable to use about 1,950 LEDs are used in total. In this case, the power consumption of the backlight device 3 would be about 210 W.

Moreover, the backlight device 3 is not limited to a direct type backlight as described above and may be an edge-light type backlight in which a light source is disposed on a side surface of a light-guiding body.

Furthermore, although each of the above-described preferred embodiments showed an exemplary configuration including color filter of the three primary colors of RGB, the present invention also can be carried out using a configuration including color filters of three colors of CMY. Further, color filters applicable to the present invention are not limited to color filter of three colors, and the technical scope of the present invention encompasses a configuration including color filters of four or more colors including a color other than three colors that exhibit white when mixed (RGB or CMY). Further, although in each of the above-described preferred embodiments, at a first half of one frame time period, a portion constituted of green pixels in one image was displayed, and at a latter half thereof, portions constituted of red pixels and green pixels were displayed. However, a configuration also may be adopted in which at a first half, portions constituted of red pixels and blue pixels in one image are displayed, and at a latter half, a portion constituted of green pixels is displayed.

Furthermore, each of the above-described preferred embodiments showed an exemplary configuration in which two types of light sources, i.e. a light source that emits light having a spectrum principally in a wavelength region of green and a light source of light having a spectrum principally in wavelength regions of red and blue were used as light sources for a backlight device. However, since deterioration in color purity is caused mainly by color mixing of green and blue, it is only required that a green component and a blue component be separated from each other. Thus, obviously, a configuration using two types of light sources that are a light source that emits light having a spectrum principally in a wavelength region of blue and a light source of light having a spectrum principally in wavelength regions of red and green also is suitable as a preferred embodiment of the present invention and provides an effect equivalent to the effect obtained by each of the above-described preferred embodiments. Further, in the case of using LEDs as light sources for a backlight device, a configuration may be adopted in which at one of a first half and a latter half of one frame time period, blue light-emitting diodes are caused to emit light, while red light-emitting diodes and green light-emitting diodes are caused to emit light simultaneously, and an effect equivalent to the effect obtained by each of the above-described preferred embodiments is provided by this configuration.

Moreover, a configuration also may be adopted in which with respect to a first light source that emits light of a first color and a second light source that emits light of a second color complementary to the first color, one of the first light source and the second light source is formed of a cold cathode tube, and the other is formed of an LED. In an example that is no more than illustrative, a cold cathode tube may be used as a light source that emits light having a spectrum principally in a wavelength region of green, and an LED including a red light-emitting element and a blue light-emitting element may be used as a light source of light having a spectrum principally in wavelength regions of red and blue. That is, in the preferred embodiments of the present invention, any design change can be made suitably in terms of the number of light sources and a combination of types of light sources as long as the effects and advantages of the present invention can be provided.

The present invention is industrially useful as an illumination device used as a backlight of a display apparatus and a display apparatus provided with the same.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-18. (canceled)

19: An illumination device used as a backlight of a display apparatus, comprising:
a first light source that emits light of a first color; and
a second light source that emits light of a second color complementary to the first color; wherein
the first light source and the second light source can be controlled so as to be switched on independently of each other.

20: The illumination device according to claim 19, wherein the light of the first color has a spectrum principally in a wavelength region of green, and the light of the second color has a spectrum principally in wavelength regions of red and blue.

21: The illumination device according to claim 19, wherein the light of the first color has a spectrum principally in a wavelength region of blue, and the light of the second color has a spectrum principally in wavelength regions of red and green.

22: The illumination device according to claim 19, wherein each of the first light source and the second light source is a cold cathode fluorescent tube or a hot cathode fluorescent tube.

23: The illumination device according to claim 22, wherein a plurality of the first light sources and a plurality of the second light sources are provided and arranged so as to alternate with each other one by one or in sets of a plural number of the first or second light sources.

24: The illumination device according to claim 19, wherein the first light source is a green light-emitting diode, and the second light source includes a red light-emitting diode and a blue light-emitting diode that emits light at a same time that the red light-emitting diode emits light.

25: The illumination device according to claim 19, wherein the first light source is a blue light-emitting diode, and the second light source includes a red light-emitting diode and a green light-emitting diode that emits light at a same time that the red light-emitting diode emits light.

26: A display apparatus, comprising:
a display element including:
scanning lines and data lines that are arranged in a matrix form;
a switching element that is connected to each of the scanning lines and a corresponding one of the data lines;
a pixel portion arranged to perform a gradation display in accordance with a data signal written from the corresponding one of the data lines when the switching element is brought to an ON state based on a signal of the each of the scanning lines; and
color filters that are arranged so as to correspond to the pixel portions and include at least filters of three colors that exhibit a white color when mixed;
an illumination device that outputs plane-shaped light to the display element and includes a first light source that emits light of a first color that is one of the three colors and a second light source that emits light of a second color complementary to the first color;
a scanning line driving portion that sequentially supplies a selection signal to each of the scanning lines at a cycle of half a time period in which one image is displayed in the display element;
a data line driving portion that, at one of a first half and a latter half of the time period in which one image is displayed in the display element, supplies a data signal to be written into each in a group of pixel portions among the pixel portions that corresponds to the color filter of the first color to a corresponding one of the data lines, and at another of the first half and the latter half of the time period, supplies a data signal to be written into each in groups of pixel portions among the pixel portions that correspond respectively to the color filters of two colors among the three colors other than the first color to a corresponding one of the data lines; and
a light source driving portion that, at the one of the first half and the latter half of the time period in which one image is displayed in the display element, switches on the first light source while switching off the second light source, and at the other of the first half and the latter half of the time period, switches on the second light source while switching off the first light source.

27: The display apparatus according to claim 26, wherein at one of the first half and the latter half of the time period in which one image is displayed in the display element, the data line driving portion supplies a data signal for causing each in the groups of pixel portions among the pixel portions that correspond respectively to the color filters of two colors among the three colors other than the first color to perform a black gradation display to a corresponding one of the data lines, and at another of the first half and the latter half of the time period in which one image is displayed in the display element, the data line driving portion supplies a data signal for causing each in the group of pixel portions among the pixel portions that corresponds to the color filter of the first color to perform a black display to a corresponding one of the data lines.

28: The display apparatus according to claim 26, wherein in the illumination device, a plurality of the first light sources and a plurality of the second light sources are arranged in a direction that is substantially perpendicular to the scanning lines, and at one of the first half and the latter half of the time period in which one image is displayed in the display element, the light source driving portion switches on the plurality of the first light sources successively in an order of arrangement so as to be synchronized with an application of the selection signal to each of the scanning lines, and at another of the first half and the latter half of the time period in which one image is displayed in the display element, the light source driving portion switches on the plurality of the second light sources successively in an order of arrangement so as to be synchronized with the application of the selection signal to each of the scanning lines.

29: The display apparatus according to claim 26, further comprising an interpolation data generating portion that generates a data signal to be supplied to one of the data lines at the latter half of the time period in which one image is displayed in the display element by performing interpolation between a data signal to be supplied to the one of the data lines in said time period and a data signal to be supplied to the one of the data lines in a time period subsequent to said time period.

30: The display apparatus according to claim 26, wherein the light of the first color has a spectrum principally in a wavelength region of green, and the light of the second color has a spectrum principally in wavelength regions of red and blue.

31: The display apparatus according to claim 26, wherein the light of the first color has a spectrum principally in a wavelength region of blue, and the light of the second color has a spectrum principally in wavelength regions of red and green.

32: The display apparatus according to claim 26, wherein each of the first light source and the second light source is a cold cathode fluorescent tube or a hot cathode fluorescent tube.

33: The display apparatus according to claim 32, wherein a plurality of the first light sources and a plurality of the second light sources are provided and arranged so as to alternate with each other one by one or in sets of a plural number of the first or second light sources.

34: The display apparatus according to claim 26, wherein the first light source is a green light-emitting diode, and the second light source includes a red light-emitting diode and a blue light-emitting diode that emits light at a same time that the red light-emitting diode emits light.

35: The display apparatus according to claim 26, wherein the first light source is a blue light-emitting diode, and the second light source includes a combination of a red light-emitting diode and a green light-emitting diode that emits light at a same time that the red light-emitting diode emits light.

36: The display apparatus according to claim 26, wherein the display element is a liquid crystal display element including a liquid crystal layer.
